(19) United States
(12) Patent Application Publication
(10) Pub. No.: US 2011/0211069 A1
(43) Pub. Date: Sep. 1, 2011

(54) VIRTUAL INTERNET PROTOCOL MODULATOR

(76) Inventor: Bryan Sybesma, Fishers, IN (US)

(21) Appl. No.: 13/035,290

(22) Filed: Feb. 25, 2011

Related U.S. Application Data
(60) Provisional application No. 61/308,585, filed on Feb. 26, 2010.

(51) Int. Cl. H04N 7/18

(52) U.S. Cl. 348/143; 348/E07.085

(57) ABSTRACT

A virtual internet protocol (“IP”) modulator that allows for the viewing of streaming video from IP based network security cameras on a television receiver, set-top box, or other digital media device. The virtual IP modulator translate streaming video information from a particular communication protocol being used by the camera to a format which is more easily recognize by the television, set-top box, or other digital media device. The virtual IP modulator may be used privately within a home or within a virtual neighborhood watch program. The virtual IP modulator may receive video directly from the camera over the network or through an intermediate web server, with the intermediate web server further translating or formatting the video information to conform with a communication protocol which is recognizes by the virtual IP modulator.

### REFERENCE TO RELATED APPLICATION

The present application claims the benefit of U.S. Provisional Patent Application Ser. No. 61/308,585 filed Feb. 26, 2010 entitled VIRTUAL INTERNET PROTOCOL MODULATOR which is hereby incorporated by reference in its entirety.

### FIELD OF THE INVENTION

The present disclosure generally relates to viewing of video from security cameras. The present disclosure specifically relates to a virtual internet protocol (“IP”) modulator for viewing video frames from IP based network cameras over an IP network using a television receiver, set top box, or digital media device.

### BACKGROUND

Network security cameras plug into an Ethernet network and use standard IP protocols to transmit Motion JPEG, MPEG or H.264 video. However, such cameras are typically deployed for closed-circuit television (CCTV) surveillance and either encrypt or otherwise modify the signals before transmitting the signals over an IP network, making it difficult to view the video images without the use of proprietary software supplied by the camera manufacturer. The present disclosure advances the private use of such network cameras over an IP network to a television receiver, set top box, or other digital media device connected to the television, allowing a user to view the images on devices which are already present in the home or business environment.

### SUMMARY OF THE INVENTION

According to one aspect, a security system is disclosed, comprising a network camera utilizing an internet protocol to transmit digital video images over an IP network, a television connected to the IP network, and a virtual internet protocol modulator in communication with the network camera and the television; wherein the virtual internet protocol modulator is configured to receive the digital video images from the network camera and output the images for viewing on the television. The security system may further comprise a web server connected to said IP network, wherein the digital video images from the network camera are received by the web server and then transmitted to the virtual internet protocol modulator for viewing on the television.

According to another aspect, a security system is disclosed, comprising a network camera utilizing an internet protocol to transmit digital video images over an IP network, set-top box connected to the IP network, television display connected to the set-top box; and virtual internet protocol modulator in communication with the network camera and the television, said virtual internet protocol modulator being implemented within said set-top box, wherein the virtual internet protocol modulator is configured to receive the digital video images from the network camera and output the images for viewing on the television.

According to yet another aspect, a digital media device for implementing a security system is disclosed, comprising a processor, a memory operatively coupled to said processor, and an IP network communication device, wherein said processor executes computer readable code to process digital video images from an IP network camera using said IP network communication device and output said digital video images over an output channel of said digital media device for display on a television.

According to yet another aspect, a method for transmitting digital video images is disclosed, comprising: receiving digital video images from a security camera over an IP network, formatting the digital video images to conform with a format suitable for use within a display connected to a digital media device, and outputting the digital video images to a television display using the digital media device.

According to yet another aspect, a method for transmitting digital video images is disclosed, comprising: receiving digital video images from a security camera over a public IP network using a communication protocol associated with the security camera, said receiving performed by a web server located remotely from the physical location of the security camera, transmitting the digital video images to a virtual internet protocol modulator using a second communication format associated with a virtual internet protocol modulator, said virtual internet protocol modulator located within at least one of a set-top box or a digital media device, and outputting the digital video images to a television display using a channel of the set-top box or digital media device.

The foregoing embodiment and other embodiments of the present disclosure as well as various features and advantages of the present disclosure will become further apparent from the following detailed description of various embodiments of the present disclosure read in conjunction with the accompanying drawings. The detailed description and drawings are merely illustrative of the present disclosure rather than limiting, the scope of the present disclosure being defined by the appended claims and equivalents thereof.

### BRIEF DESCRIPTION OF THE DRAWINGS

FIG. 1 is a diagrammatic view which illustrates a security system in accordance with one embodiment of the present disclosure.

### DETAILED DESCRIPTION

For the purposes of promoting and understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

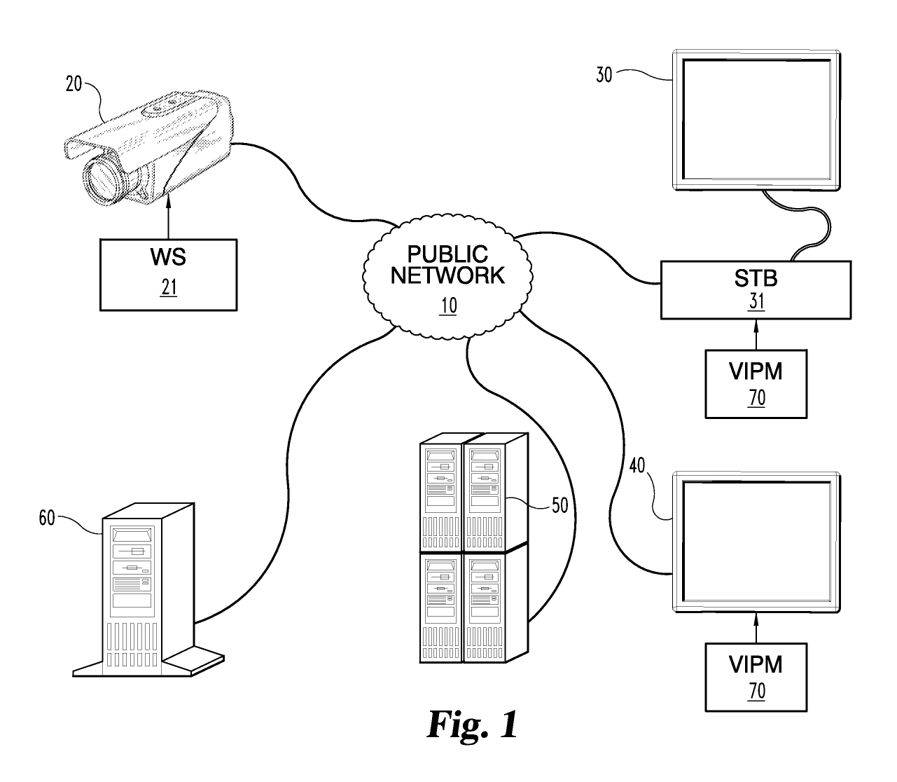

FIG. 1 illustrates a network security camera 20 having an internal web server 21, a television 30 having a set-top box 31 (e.g., a DirecTV receiver); a television 40 having an internal receiver; and application server 50; and a web server 60. All of the illustrated devices are connected, wired or wirelessly, to a network 10 (e.g., the Internet) as shown.

Network 10 is preferably the Internet, which is a TCP/IP based global network; however, the user of the term “Internet” herein shall be understood to refer to at least a portion of any interconnected electronic network which interchanges data by packet-switching or some other technology. In addition, portions of the network 10 may comprise a private in-home network, such as a local area network (“LAN”) for connecting the televisions 30 and 40 to cameras 20 located within the home, while other public portions of the network 10 are used to allow communication between the application server 50 and the televisions 30 and 40 or set-top box 31.

The televisions 30 and 40 may comprise any type of digital video display known in the art, including liquid crystal displays (“LCD”), plasma displays, light emitting diode displays (“LED”) and the like.

In a preferred embodiment, Virtual IP (“VIP”) modulator 70 is a software based application consisting of computer readable code that allows for the viewing of streaming video from one or more network security cameras 20 on televisions 30 and 40. Security network cameras, such as network camera 20, typically transmit video in an encrypted or otherwise proprietary format to prevent unauthorized users from viewing the images. The VIP modulator is configured to translate the video information from the format used by the camera manufacturer to a format which is readable by a device already present in the user's home or business, such as a set-top box 31, or television receiver 40. Without the virtual internet protocol modulator, the set-top box 31 or television 40 would not be able to view the video images, as the devices are typically only capable of viewing standard “web push” video information from public network sources. The virtual internet protocol modulator 70 therefore allows the user to view video images from the security camera 20 using their television 30 or 40 in a simplified manner.

VIP modulator 70 may be downloaded from application server 50 (e.g., a DirecTV® application store) and conforms to an operating system (“OS”) of the set-top box 31 or the receiver of television 40. Using the hand-held remote control or other control device of television 30 and 40 or set-top box 31, the OS is directed to an address of internal web server 21 of each network camera 20. The address may include an IP address, a dynamic Domain Name Service (“DNS”), or other network address formats known in the art. Once at web server 21, a username and password are entered in the VIP modulator 70 application or OS via the remote control for future access. Alternatively, the username and password may be entered in the VIP modulator 70 via the application server 50 prior to the VIP modulator 70 being downloaded to televisions 30 and 40.

In further embodiments, VIP modulator 70 may be implemented using hardware, firmware and/or software in combination as would be appreciated by those having ordinary skill in the art. When implemented in software, the VIP modulator 70 may be written or configured using any computer language known in the art, including, but not limited to, C++, C#, Java, and the like. Furthermore, the VIP modulator 70 may be configured to conform and communicate with the OS by utilizing standard developer kit (“SDK”) commands and program modules.

Each of the servers 50 and 60, set-top box 31, televisions 30 and 40, and cameras 20 may comprise one or more processors, memory, and digital storage devices, in addition to IP network communication devices and hardware to achieve connectivity with the network 10.

In operation, the VIP modulator 70 accesses streaming video from network camera(s) 20 for display on televisions 30 and 40 as a standalone channel or as a picture in the picture box of the menu or on-screen guide of the set-top box 31 or televisions 30 and 40. VIP modulator 70 may allow for a 2×2 matrix to display up to four network cameras 20 on one screen. Additional matrix, split screen, or rolling time-based formats may also be used to display images from multiple cameras 20. The VIP modulator may also allow the user to select video from a specific camera 20 at will using a remote control of the television 30 or 40 or set-top box 31.

VIP modulator 70 may conform to the communication protocols of various types of network cameras 20. Thus, a setup page within the VIP modulator 70 application and/or application server 50 may be provided for each type of network camera 20 that is intended to be used with the system. Once the network camera(s) 20 have been added to VIP modulator 70, the remote control of televisions 30 or 40 or set-top box 31 may be used to control pan, tilt and zoom functions of the network camera(s) 20.

In certain embodiments, a separate web server, such as web server 60, may act as an intermediary between the camera 20 and the televisions 30 or 40 or set-top box 31, wherein the web server 60 is located remotely from the home or installed location of cameras 20 and televisions 30 and 40. For example, the web server 60 may optionally contain a software application which can be configured to conform to the particular communication protocol of the camera(s) 20 being used. The VIP modulator 70 can then be configured to conform to a single protocol for communication with the web server 60. This alleviates the need to provide separate versions of or updates to the VIP modulator program as new camera protocols are develop or put into use by the camera manufacturers. In such an embodiment, the streaming video is transmitted from the camera 20 (via internal web server 21) to web server 60 using network 10 (typically the Internet). The web server 60 then executes computer readable code to translate or format the video signal into a format that can already be read by the virtual internet protocol modulator 70. The video is then transmitted from web server 60 to the virtual internet protocol modulator 70 in television 40 or set-top box 31 using network 10. The virtual internet protocol modulator application 70 then further translates the video signal into a format recognized by the television 40 or set-top box 31, after which the video is output to the television 30 or 40 as discussed above.

In addition to a television receiver or set-top box, the VIP modulator may be implemented within other types of digital media devices. For example, VIP modulator may be implemented within a digital video disc (“DVD”) player, a Blu-ray player, or other digital video player suitable for playing movies or other video content. The digital media device receives the video information from camera(s) 20. Virtual IP modulator 70 then translates the video stream information as described above and outputs the information to a channel of television 40 or set-top box 31.

Referring again to FIG. 1, in one embodiment, televisions 30 and 40 may be located within a residential home with the network camera(s) 20 being situated at strategic locations around the home and/or other location for security surveillance.

In further embodiments, a security system of network cameras 20 and websites 60 may be used to implement a virtual neighborhood watch program. For example, a home owner's association, a property management company, individual homeowners or any property association may establish network access to the network cameras 20 as strategically situated in the neighborhood (e.g., bus stops, common areas, community entrance/exit, etc.). Typically, a network router (not shown) may be used to partition bandwidth for the association's members private use of the security system. This bandwidth may be used for the uploading of the streaming videos from the camera(s) 20 to the web server 60 for private use by the association. Web server 60 may implement username and password protocols to prevent unauthorized access.

In addition, network cameras 20 and websites 60 may serve as a powerful tool for law enforcement. For example, the local law enforcement agency may be provided access to websites 60 for their area in order to view the streaming video from the network cameras 20 within the jurisdiction of the agency. As a result, a dispatcher or officer may view the area of a disturbance via a PC or television prior to arriving on the scene.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

What is claimed is:

1. A security system, comprising:
a network camera utilizing an internet protocol to transmit digital video images over an IP network;
a television connected to the IP network; and
a virtual internet protocol modulator in communication with the network camera and the television;
wherein the virtual internet protocol modulator is configured to receive the digital video images from the network camera and output the images for viewing on the television.

2. The security system of claim 1, wherein the virtual internet protocol modulator comprises computer readable code which resides within a memory of said television and conforms to an operating system of said television.

3. The security system of claim 1, further comprising:
a web server connected to said IP network;
wherein the digital video images from the network camera are received by the web server and then transmitted to the virtual internet protocol modulator for viewing on the television.

4. The security system of claim 1, wherein the network camera comprises an internal web server to enable communication with the IP network.

5. The security system of claim 1, wherein the virtual internet protocol modulator is configured to display the digital video images within a picture box of an on-screen menu of the television.

6. The security system of claim 1, wherein the digital video images are stored in a digital storage device within the television for later retrieval and viewing.

7. The security system of claim 1, wherein the security system comprises multiple network cameras connected to the IP network, and wherein digital video images from each of the cameras are displayed simultaneously on the television in a matrix pattern.

8. The security system of claim 1, wherein the IP network is a public IP network.

9. The security system of claim 1, wherein the IP network is a private IP network.

10. The security system of claim 1, wherein the IP network contains both public and private portions.

11. A security system, comprising:
a network camera utilizing an internet protocol to transmit digital video images over an IP network;
a set-top box connected to the IP network;
a television display connected to the set-top box; and
a virtual internet protocol modulator in communication with the network camera and the television, said virtual internet protocol modulator being implemented within said set-top box;
wherein the virtual internet protocol modulator is configured to receive the digital video images from the network camera and output the images for viewing on the television.

12. The security system of claim 11, wherein the virtual internet protocol modulator comprises computer readable code which resides within a memory of said television and conforms to an operating system of said television.

13. The security system of claim 11,
wherein the virtual internet protocol modulator is configured to conform to the communication protocol of the network camera with respect to received digital video images; and
wherein the virtual internet protocol modulator is further configured to conform to the operating system of the set-top box.

14. A digital media device for implementing a security system, comprising:
a processor; and
a memory operatively coupled to said processor;
an IP network communication device;
wherein said processor executes computer readable code to process digital video images from an IP network camera using said IP network communication device and output said digital video images over an output channel of said digital media device for display on a television.

15. The digital media device of claim 14, wherein said digital media device further functions as a set-top box for use with a television.

16. The digital media device of claim 15, wherein the digital video images are stored within the memory for later retrieval.

17. The digital media device of claim 15, wherein said digital video images are output within a picture box of an on-screen guide of the set-top box.

18. The digital media device of claim 14, wherein said images from multiple network cameras are displayed simultaneously in a matrix format to the television.

19. The digital media device of claim 14, wherein the digital media device received said digital video images from an intermediate web server, said web server in communication with said network camera over an IP network.

20. The digital media device of claim 14, wherein said digital media device is further configured to play digital videos received from other source in addition to the network cameras.
